(19) United States
(12) Patent Application Publication
(10) Pub. No.: US 2024/0272646 A1
(43) Pub. Date: Aug. 15, 2024

(54) SWIMMING POOL ROBOT AND CONTROL METHOD THEREOF

(71) Applicant: Shenzhen Seauto Technology Co., Ltd.

(72) Inventor: ZHUOMING DENG, Shenzhen (CN)

(21) Appl. No.: 18/010,787

(22) PCT Filed: Nov. 9, 2022
(86) PCT No.: PCT/CN2022/130767

§ 371 Date: Dec. 15, 2022

(30) Foreign Application Priority Data
Sep. 28, 2022 (CN) 202211188042.3

(51) Int. Cl. G05D 1/648; B63H 1/14; B63H 21/17; E04H 4/16; G05D 1/228; G05D 109/30

(52) U.S. Cl. CPC G05D 1/648; B63H 1/14; B63H 21/17; E04H 4/1654; G05D 1/2287; G05D 2109/38

(57) ABSTRACT

The present disclosure provides a swimming pool robot and a control method of the swimming pool robot. The swimming pool robot includes: a vehicle body; a power switch and a water intake detection module both arranged at a bottom of the vehicle body; a first water outlet and a second water outlet arranged opposite to each other at a top of the vehicle body; and a battery, an MCU, a body state detection module for detecting a state of the vehicle body, an electric power reserve detection module for detecting an electric power reserve of the battery, a first driving mechanism for driving the first water outlet to discharge water, and a second driving mechanism for driving the second water outlet to discharge water are arranged inside of the vehicle body, wherein each of the battery, the power switch, the water intake detection module, the body state detection module, the electric power reserve detection module, the first drive mechanism and the second drive mechanism is individually connected to the MCU. According to the present disclosure, after the swimming pool robot is started up, the first driving mechanism or the second driving mechanism is opened only when the swimming pool robot in the water, and sinks into the bottom under the action of its own gravity and is in the static state, so as to drive the first water outlet or the second water outlet to discharge water, so that the swimming pool robot advances in the swimming pool to achieve the dirt suction function, the settling time of the swimming pool robot is reduced, thereby improving the cleaning efficiency.

### TECHNICAL FIELD

The disclosure relates to the technical field of robot, and in particular to a swimming pool robot and a control method thereof.

### BACKGROUND

Cleaning of a swimming pool is generally divided into two types: one is to filter water quality of the swimming pool by a water filtering machine, and the other is to clean dirt of the bottom and side walls of the swimming pool by a robot.

Most current swimming pool robots are defined with a drainage outlet on a vehicle body. A motor starts synchronously after the swimming pool robot starts, then the swimming pool robot is put into the swimming pool. The swimming pool robot is powered by a reaction force generated by the motor driving the drainage of the drainage outlet. However, in this manner, because the motor has already started before the swimming pool robot sinks to a bottom of the swimming pool, exhaust gas from the motor may entrapped inside the swimming pool robot, which causes the swimming pool robot sinking to the bottom very slowly, and may not even sink to the bottom at all. The cleaning process is no efficient.

### SUMMARY OF INVENTION

The main objective of the present disclosure is to provide a swimming pool robot and a control method therefor, which are intended to reduce the time for sinking the swimming pool robot to the bottom of a pool, thereby improving the cleaning efficiency.

In order to solve the above-mentioned technical problem, a swimming pool robot is provided, the swimming pool robot comprising: a vehicle body; a power switch and a water intake detection module both arranged at a bottom of the vehicle body; a first water outlet and a second water outlet arranged opposite to each other at a top of the vehicle body; and a battery, an MCU, a body state detection module for detecting a state of the vehicle body, an electric power reserve detection module for detecting an electric power reserve of the battery, a first driving mechanism for driving the first water outlet to discharge water, and a second driving mechanism for driving the second water outlet to discharge water are arranged inside of the vehicle body, wherein each of the battery, the power switch, the water intake detection module, the body state detection module, the electric power reserve detection module, the first drive mechanism and the second drive mechanism is individually connected to the MCU.

The further technical solution of the present disclosure is that the water intake detection module comprises a metal electrode arranged at the bottom of the vehicle body.

The further technical solution of the present disclosure is that the body state detection module comprises an IMU arranged inside of the vehicle body.

The further technical solution of the present disclosure is that the bottom of the vehicle body is defined with a water inlet, and the water inlet is in air communicated with the first water outlet to form a first water channel, and is in air communicated with the second water outlet to form a second water channel, the first drive mechanism comprises a first driving motor arranged in the vehicle body, and a first propeller arranged in the first water channel and connected to the first driving motor, the second drive mechanism comprises a second driving motor arranged in the vehicle body, and a second propeller arranged in the second water channel and connected to the second driving motor, and the MCU is connected to the first driving motor and the second driving motor respectively.

The further technical solution of the present disclosure is that each of the water inlet, the first water outlet and the second water outlet comprises a one-way valve.

The further technical solution of the present disclosure is that four wheels are arranged at four corners of the bottom of the vehicle body, and at least two of the four wheels cannot be rotated, so as to ensure that the swimming pool robot moves forward or backward in a straight line.

The further technical solution of the present disclosure is that the vehicle body comprises an arc structure.

The beneficial effect of the swimming pool robot of the present disclosure is that by the described technical solution, the swimming pool robot of the present disclosure comprises the vehicle body, the power switch and the water intake detection module both are arranged at the bottom of the vehicle body, and the first water outlet and the second water outlet are arranged opposite to each other at the top of the vehicle body, the battery, the MCU, the body state detection module for detecting the state of the vehicle body, the electric power reserve detection module for detecting the electric power reserve of the battery, the first driving mechanism for driving the first water outlet to discharge water, and the second driving mechanism for driving the second water outlet to discharge water are arranged in the vehicle body, the battery, the power switch, the water intake detection module, the body state detection module, the electric power reserve detection module, the first drive mechanism and the second drive mechanism are respectively connected to the MCU, after the swimming pool robot is started up, the first driving mechanism or the second driving mechanism is opened only when the swimming pool robot in the water, and sinks into the bottom of the swimming pool under the action of its own gravity and is in the static state, so as to drive the first water outlet or the second water outlet to discharge water, so that the swimming pool robot advances in the swimming pool to achieve the dirt suction function, the settling time of the swimming pool robot is reduced, thereby improving the cleaning efficiency.

In order to solve the above-mentioned technical problem, a control method of a swimming pool robot is also provided, the control method is applied to the swimming pool robot as described above, and the control method comprises: after starting-up the swimming pool robot, acquiring the vehicle body state of the swimming pool robot; determining whether the swimming pool robot meets the dirt suction condition according to the vehicle body state, wherein the dirt suction condition comprises that the vehicle body is in the water and stays in a bottom of a swimming pool in a static state; if the vehicle body state meets the dirt suction condition, starting-up one of the first driving mechanism and the second driving mechanism to drive a corresponding one of the first water outlet and the second water outlet to discharge water, and then the swimming pool robot moves forward in a swimming pool.

The further technical solution of the present disclosure is that after the step of if the vehicle-body state meets the dirt suction condition, driving one of the first water outlet and the second water outlet to discharge water, and then the swimming pool robot moves forward in a swimming pool, further comprises: determining whether the vehicle body collides with a sidewall of the swimming pool and turns; and if yes, switching the first driving mechanism or the second driving mechanism, so as to switch the drainage of the first water outlet or the second water outlet to drive the swimming pool robot to perform a steering movement.

The further technical solution of the present disclosure is that the control method further comprises: acquiring the current electric power reserve of the battery; comparing the current electric power reserve with a preset threshold, when the current electric power reserve is less than or equal to the preset threshold, executing a low power and edge-abutting model.

The control method for the swimming pool robot of the present disclosure has the following beneficial effects: in the present disclosure, by the described technical solution, after starting-up the swimming pool robot, acquiring the vehicle body state of the swimming pool robot, determining whether the swimming pool robot meets the dirt suction condition according to the vehicle body state, wherein the dirt suction condition comprises that the vehicle body is in the water and stays in the bottom of the swimming pool in the static state, if the vehicle body state meets the dirt suction condition, starting-up one of the first driving mechanism and the second driving mechanism to drive the corresponding one of the first water outlet and the second water outlet to discharge water, and then the swimming pool robot moves forward in a swimming pool. After the swimming pool robot is started up, only when the swimming pool robot is located in the water, the swimming pool robot sinks into the bottom of the swimming pool under the action of its own gravity and is in the static state, the first driving mechanism or the second driving mechanism is started up, so as to drive the first water outlet or the second water outlet to discharge water, so that the swimming pool robot advances in the swimming pool to realize the dirt suction function.

### BRIEF DESCRIPTION OF DRAWINGS

To describe the technical solutions in the embodiments of the present disclosure or in the prior art more clearly, the following briefly introduces the drawings required for describing the embodiments or the prior art. Apparently, the drawings in the following description are only some embodiments of the present disclosure, other drawings may also be obtained according to structures shown in these drawings without creative efforts.

FIG. 1 is an exploded view of a swimming pool robot according to a preferred embodiment of the present disclosure.

FIG. 2 is a schematic diagram of an overall structure of the swimming pool robot according to a preferred embodiment of the present disclosure.

FIG. 3 is a front view of the swimming pool robot according to a preferred embodiment of the present disclosure.

FIG. 4 is a bottom view of the swimming pool robot according to a preferred embodiment of the present disclosure.

FIG. 5 is a top view of the swimming pool robot according to a preferred embodiment of the present disclosure.

FIG. 6 is a sectional view taken along the A-A direction in FIG. 5.

FIG. 7 is a system frame diagram of the swimming pool robot according to a preferred embodiment of the present disclosure.

FIG. 8 is a schematic flowchart of a control method of the swimming pool robot according to a preferred embodiment of the present disclosure.

### DETAILED DESCRIPTION

The technical solutions in the embodiments of the present disclosure will be described clearly and completely below in combination with the drawings in the present disclosure. Obviously, the described embodiments are only part of the embodiments of the present disclosure, not all of them. Based on the embodiments of the present disclosure, all other embodiments obtained by ordinary technicians in the field without creative work belong to the scope of protection of the present disclosure.

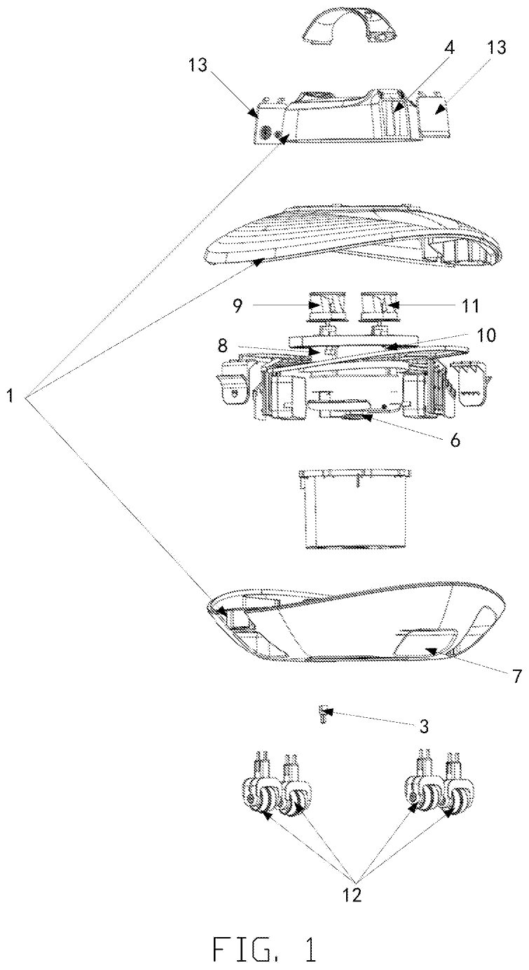

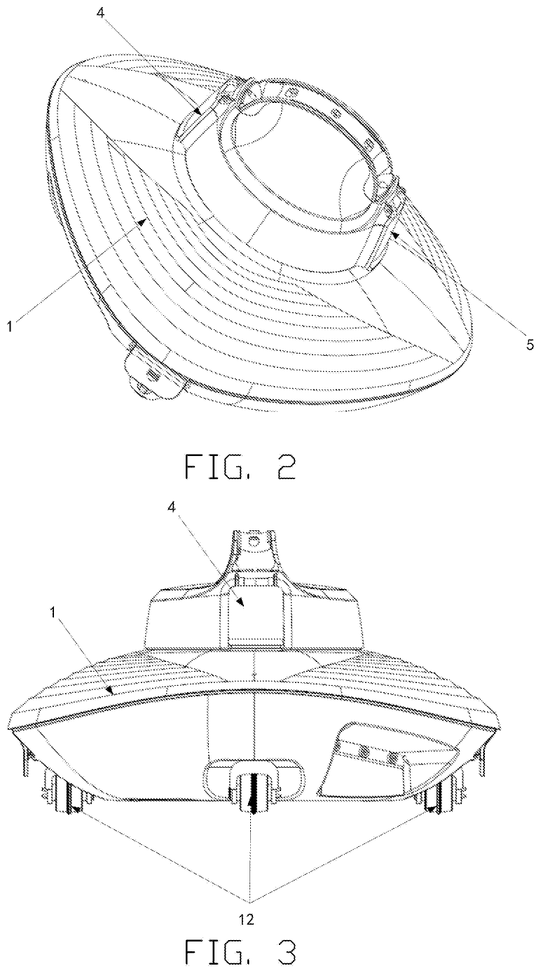

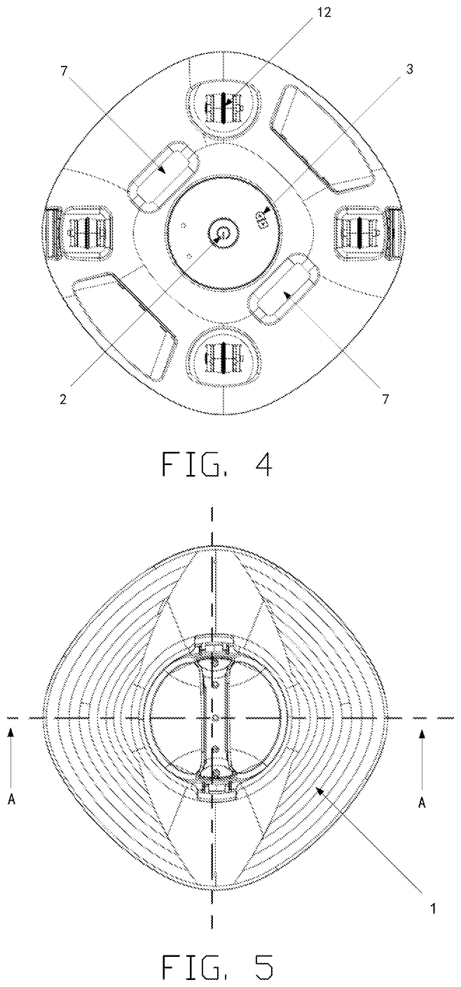

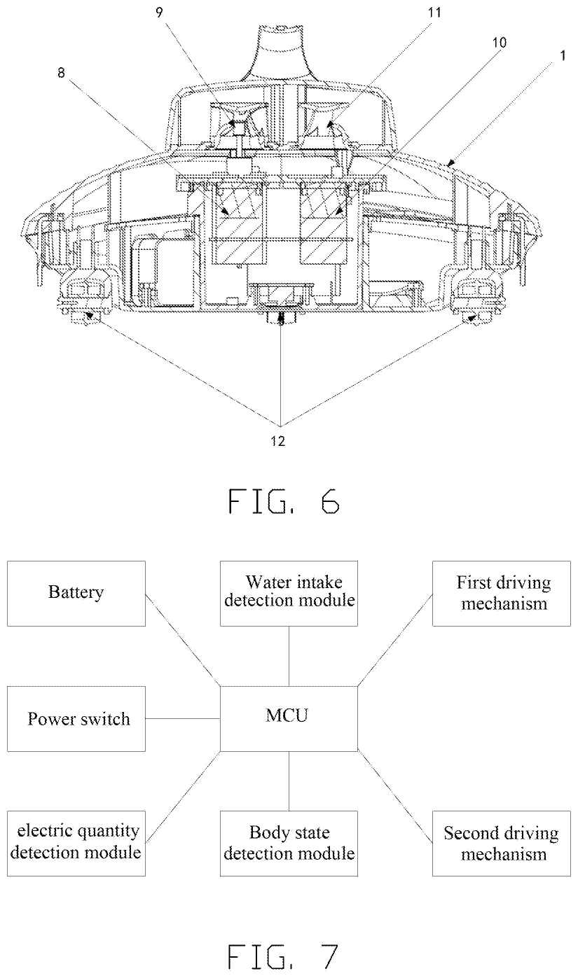

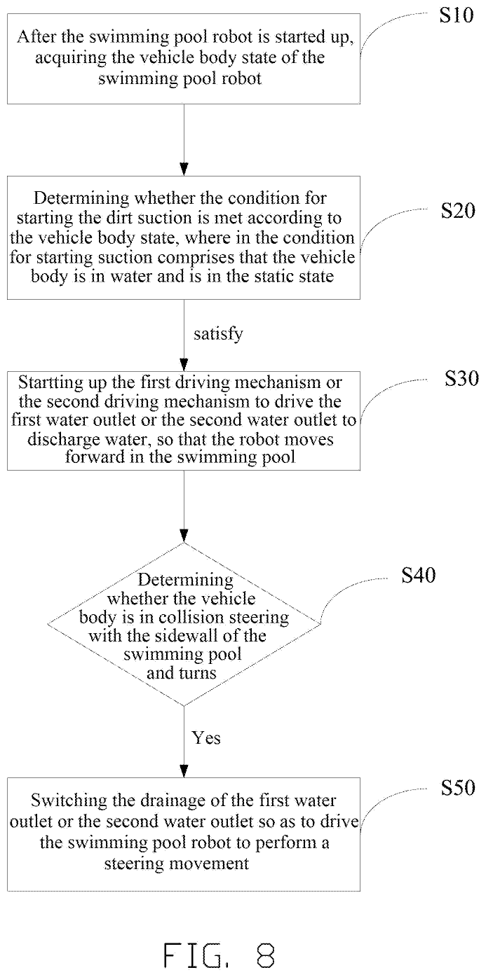

Referring to FIGS. 1 to 7, the present disclosure provides a swimming pool robot. A preferred embodiment of the swimming pool robot of the present disclosure comprises a vehicle body 1, a power switch 2 and a water intake detection module both are arranged at a bottom of the vehicle body 1, and a first water outlet 4 and a second water outlet 5 are arranged opposite to each other at a top of the vehicle body 1, a battery 6, an MCU, a body state detection module for detecting the state of the vehicle body, an electric power reserve detection module for detecting an electric power reserve of the battery 6, a first driving mechanism for driving the first water outlet 4 to discharge water, and a second driving mechanism for driving the second water outlet 5 to discharge water are arranged inside of the vehicle body 1, each of the battery 6, the power switch 2, the water intake detection module, the body state detection module, the electric power reserve detection module, the first drive mechanism and the second drive mechanism is individually connected to the MCU.

In this embodiment, the MCU is configured for acquiring a vehicle body state of the swimming pool robot after the swimming pool robot is started up. Determine the swimming pool robot meets the dirt suction condition according to the vehicle body state, wherein the dirt suction condition comprises that the vehicle body 1 is in the water and stays in a bottom in a static state. If the vehicle body state meets the dirt suction condition, starting-up one of the first driving mechanism and the second driving mechanism to drive a corresponding one of the first water outlet 4 and the second water outlet 5 to discharge water, and then the swimming pool robot moves forward in the swimming pool.

Considering that most current swimming pool robots are defined with a drainage outlet on the vehicle body 1, a motor starts synchronously after the swimming pool robot starts, then the swimming pool robot is put into the swimming pool. The swimming pool robot is powered by a reaction force generated by the motor driving the drainage of the drainage outlet. However, in this manner, because the motor has already started before the swimming pool robot sinks to the bottom of the swimming pool, which causes the swimming pool robot sinking to the bottom very slowly, and may not sink to the bottom at all, and the cleaning process is no efficient. Therefore, in this embodiment, the water intake detection module is arranged at the bottom of the vehicle body 1, the body state detection module is arranged in the vehicle body 1, the water intake detection module detects whether the vehicle body 1 of the swimming pool robot is in the water, and the body state detection module detects whether the swimming pool robot has been located at the bottom of a swimming pool and is in a static state. After the swimming pool robot is started up, only when the swimming pool robot is located in the water, the swimming pool robot sinks into the bottom of the swimming pool under the action of its own gravity and is in the static state, the first driving mechanism or the second driving mechanism is started up, so as to drive the first water outlet 4 or the second water outlet 5 to discharge water, so that the swimming pool robot advances in the swimming pool to realize a dirt suction function.

In this embodiment, the MCU is further configured to acquire a current electric power reserve of the battery 6, and compare the current electric power reserve of the battery 6 with a preset threshold, when the current electric power reserve of the battery 6 is less than or equal to the preset threshold, a low power and edge-abutting model is executed.

It should be noted that in this embodiment, the preset threshold may be set according to actual requirements, for example, 10.5V. When the electric power reserve detection module detects that the electric power reserve of the battery 6 is lower than the preset threshold, the first driving mechanism or the second driving mechanism is not switched, and the first driving mechanism or the second driving mechanism is stopped to work, so that the swimming pool robot keep low electric power reserve and edge-abutting.

In this embodiment, the current electric power reserve of the battery 6 may be detected in real time by the electric power reserve detection module, or the current electric power reserve of the battery 6 may be detected when the swimming pool robot is inadequate in power and has a slow speed, and then information of the current electric power reserve of the battery 6 is sent to the MCU.

Further, in this embodiment, the water intake detection module comprises a metal electrode 3 arranged at the bottom of the vehicle body 1. In a specific embodiment, two metal probes may be arranged at the bottom of the vehicle body 1.

In this embodiment, the metal electrode 3 has good electrical conductivity. When the vehicle body 1 of the swimming pool robot is located in the water, the metal electrode 3 is conducted, that is, when the MCU detects that the metal electrode 3 is conducted, it indicates that the swimming pool robot is located in the water.

Further, in this embodiment, the body state detection module comprises an IMU arranged in the vehicle body 1.

In this embodiment, the bottom of the vehicle body 1 is defined with a water inlet 7, and the water inlet 7 is in air communicated with the first water outlet 4 to form a first water channel, and the water inlet 7 is in air communicated with the second water outlet 5 to form a second water channel, the first drive mechanism comprises a first driving motor 8 arranged in the vehicle body 1, and a first propeller 9 arranged in the first water channel and connected to the first driving motor 8, the second drive mechanism comprises a second driving motor 10 arranged in the vehicle body 1, and a second propeller 11 arranged in the second water channel and connected to the second driving motor 10. The MCU is connected to the first driving motor 8 and the second driving motor 10 respectively.

When the first driving motor 8 drives the first propeller 9 to rotate, the corresponding first water outlet 4 discharges water to provide power for the swimming pool robot to move in a first direction. When the second driving motor 10 drives the second propeller 11 to rotate, the corresponding second water outlet 5 discharges water to provide power for the swimming pool robot to move in a second direction opposite to the first direction.

In this embodiment, each of the water inlet 7, the first water outlet 4 and the second water outlet 5 comprises a one-way valve 13. When a water discharge function of the first water outlet 4 or the second water outlet 5 is started, the one-way valve 13 at a position corresponding to the water inlet 7, the first water outlet 4 or the second water outlet 5 is opened.

In this embodiment, four wheels 12 are arranged at four corners of the bottom of the vehicle body 1, and at least two of the four wheels 12 cannot be rotated, so as to ensure that the swimming pool robot moves forward or backward in a straight line.

In this embodiment, the vehicle body 1 comprises an arc structure.

Specifically, in this embodiment, an edge of the vehicle body 1 is in an irregular arc shape, and a movement direction of the swimming pool robot is changed by the collision between the edge of the vehicle body 1 and the wall of the swimming pool.

In this embodiment, the MCU is further configured for determining whether the vehicle body 1 of the swimming pool robot collides with a side of the swimming pool and turns. If yes, switching the first driving mechanism or the second driving mechanism, so as to switch the first water outlet 4 or the second water outlet 5 to discharge water, thereby driving the swimming pool robot to perform steering movement and move towards the other direction.

The beneficial effect of the swimming pool robot of the present disclosure is that by the described technical solution, the swimming pool robot of the present disclosure comprises the vehicle body, the power switch and the water intake detection module both are arranged at the bottom of the vehicle body, and the first water outlet and the second water outlet are arranged opposite to each other at the top of the vehicle body, the battery, the MCU, the body state detection module for detecting the state of the vehicle body, the electric power reserve detection module for detecting the electric power reserve of the battery, the first driving mechanism for driving the first water outlet to discharge water, and the second driving mechanism for driving the second water outlet to discharge water are arranged in the vehicle body, each of the battery, the power switch, the water intake detection module, the body state detection module, the electric power reserve detection module, the first drive mechanism and the second drive mechanism is individually connected to the MCU, after the swimming pool robot is started up, the first driving mechanism or the second driving mechanism is opened only when the swimming pool robot in the water, and sinks into the bottom under the action of its own gravity and is in the static state, so as to drive the first water outlet or the second water outlet to discharge water, so that the swimming pool robot advances in the swimming pool to achieve the dirt suction function, the settling time of the swimming pool robot is reduced, thereby improving the cleaning efficiency.

In order to achieve the above object, the present disclosure further provides a control method of the swimming pool robot. Referring to FIG. 7, a preferred embodiment of the control method of the swimming pool robot of the present disclosure comprises the following steps.

In step S10, after starting-up the swimming pool robot, acquiring the vehicle body state of the swimming pool robot.

It should be noted that an execution subject in this embodiment may be the MCU, and after the swimming pool robot is started up, the MCU acquires the vehicle body state of the swimming pool robot.

The vehicle body state of the swimming pool robot may be detected by the water inflow detection module and the body state detection module.

As an implementation solution, the water intake detection module is a metal electrode arranged at the bottom of the vehicle body, and the body state detection module is the IMU arranged inside of the vehicle body. Whether the vehicle body is in the water is determined by whether the metal electrode is conductive, and whether the vehicle body is sinking and in the static state is detected by the IMU.

In step S20, determining whether the swimming pool robot meets the dirt suction condition according to the vehicle body state, wherein the dirt suction condition comprises that the vehicle body is in the water and stays in a bottom in a static state.

After acquiring the vehicle body state of the swimming pool robot, the MCU determines whether the dirt suction condition is met according to the vehicle body state, and the dirt suction condition is that the vehicle body is in the water and is in the static state.

Considering that most current swimming pool robots are defined with a drainage outlet on the vehicle body, a motor starts synchronously after the swimming pool robot starts, then the swimming pool robot is put into the swimming pool. The swimming pool robot is powered by a reaction force generated by the motor driving the drainage of the drainage outlet. However, in this manner, because exhaust gas may entrapped inside the swimming pool robot, which causes the swimming pool robot sinking to the bottom very slowly, and may not sink to the bottom at all, and the cleaning process is no efficient. Therefore, in this embodiment, the water intake detection module is arranged at the bottom of the vehicle body, the body state detection module is arranged in the vehicle body, the water intake detection module detects whether the vehicle body of the swimming pool robot is in the water, and the body state detection module detects whether the swimming pool robot has been located at the bottom of the swimming pool and is in the static state. After the swimming pool robot is started up, only when the swimming pool robot is located in the water, the swimming pool robot sinks into the bottom of the swimming pool under the action of its own gravity and is in the static state, the first driving mechanism or the second driving mechanism is started up, so as to drive the first water outlet or the second water outlet to discharge water, so that the swimming pool robot advances in the swimming pool to realize a dirt suction function.

In step S30, if the vehicle body state meets the dirt suction condition, starting-up one of the first driving mechanism and the second driving mechanism to drive a corresponding one of the first water outlet and the second water outlet to discharge water, and then the swimming pool robot moves forward in a swimming pool to realize the dirt suction function.

In this embodiment, the MCU determines that the vehicle body state meets the dirt suction condition, that is, the vehicle body is located in the water, and only when sinking into the bottom of the swimming pool under the gravity of its own and being in the static state, the MCU actuates one of the first driving mechanism and the second driving mechanism to drive the first water outlet or the second water outlet to discharge water, so that the swimming pool robot moves forward in the swimming pool to realize the dirt suction function.

Further, in this embodiment, after the step S30 of if the vehicle-body state meets the dirt suction condition, starting-up one of the first driving mechanism and the second driving mechanism to drive a corresponding one of the first water outlet and the second water outlet to discharge water, and then the swimming pool robot moves forward in a swimming pool, further comprises the following steps.

In step S40, determining whether the vehicle body collides with a sidewall of the swimming pool and turns.

Specifically, in this embodiment, the IMU arranged in the vehicle body may detect a movement speed and an acceleration direction of the vehicle body, and then send the movement speed and the acceleration direction to the MCU, and the MCU determines, according to the movement speed and the acceleration direction, whether the vehicle body collides with the sidewall of the swimming pool.

In step S50, if yes, switching the first driving mechanism or the second driving mechanism, so as to switch the drainage of the first water outlet or the second water outlet to drive the swimming pool robot to perform a steering movement.

If the vehicle body collides with the sidewall of the swimming pool and turns, the first driving mechanism or the second driving mechanism is switched to switch the first water outlet or the second water outlet to discharge water, so as to drive the swimming pool robot to rotate.

It should be noted that in order to improve a motion stability of the swimming pool robot, after it is determined that the vehicle body collides with the sidewall of the swimming pool and turns, the first driving mechanism or the second driving mechanism may be switched within 1 s, a direction can be changed and the swimming pool robot continues to move forward, and a same detection conditions will not be triggered within 5 s.

Further, in this embodiment, the control method of the swimming pool robot further comprises the following steps.

Acquiring the current electric power reserve of the battery.

In this embodiment, when the swimming pool robot is started up, the current electric power reserve of the battery may be detected in real time by the electric power reserve detection module in synchronization with step S10, or the current electric power reserve of the battery may be detected when the swimming pool robot is inadequate in power and has a slow speed, and then information of the current electric power reserve of the battery is sent to the MCU.

Comparing the current electric power reserve with a preset threshold.

When the current electric power reserve is less than or equal to the preset threshold, executing a low power and edge-abutting model.

It should be noted that in this embodiment, the preset threshold may be set according to actual requirements, for example, 10.5V. When the electric power reserve detection module detects that the electric power reserve of the battery is lower than the preset threshold, the first driving mechanism or the second driving mechanism is not switched, and the first driving mechanism or the second driving mechanism is stopped to work, so that the swimming pool robot keep low electric power reserve and edge-abutting.

The control method for the swimming pool robot of the present disclosure has the following beneficial effects: in the present disclosure, by the described technical solution, after starting-up the swimming pool robot, acquiring the vehicle body state of the swimming pool robot, determining whether the swimming pool robot meets the dirt suction condition according to the vehicle body state, wherein the dirt suction condition comprises that the vehicle body is in the water and stays in the bottom of the swimming pool in the static state, if the vehicle body state meets the dirt suction condition, starting-up one of the first driving mechanism and the second driving mechanism to drive the corresponding one of the first water outlet and the second water outlet to discharge water, and then the swimming pool robot moves forward in a swimming pool. After the swimming pool robot is started up, only when the swimming pool robot is located in the water, the swimming pool robot sinks into the bottom of the swimming pool under the action of its own gravity and is in the static state, the first driving mechanism or the second driving mechanism is started up, so as to drive the first water outlet or the second water outlet to discharge water, so that the swimming pool robot advances in the swimming pool to realize the dirt suction function.

The foregoing descriptions are merely exemplary embodiments of the present disclosure, but are not intended to limit the patent scope of the present disclosure. Any equivalent structural change made by using the description and the accompanying drawings of the present disclosure under the concept of the present disclosure, or direct/indirect application in other related technical fields, is included in the patent scope of the present disclosure.

1. A swimming pool robot comprising:
a vehicle body;
a power switch and a water intake detection module both arranged at a bottom of the vehicle body;
a first water outlet and a second water outlet arranged opposite to each other at a top of the vehicle body;
a battery
a microcontroller unit (MCU),
a body state detection module detecting a state of the vehicle body;
an electric power reserve detection module detecting an electric power reserve of the battery
a first driving mechanism driving the first water outlet to discharge water and
a second driving mechanism driving the second water outlet to discharge water,
wherein the battery, the MCU, the body state detection module, the electric power reserve detection module, the first driving mechanism, the second driving mechanism are arranged inside of the vehicle body,
each of the battery, the power switch, the water intake detection module, the body state detection module, the electric power reserve detection module, the first drive mechanism and the second drive mechanism is individually connected to the MCU.

2. The swimming pool robot according to claim 1, wherein the water intake detection module comprises a metal electrode arranged at the bottom of the vehicle body.

3. The swimming pool robot according to claim 1, wherein the body state detection module comprises an inertial measurement unit (IMU) arranged inside of the vehicle body.

4. The swimming pool robot according to claim 1, wherein the bottom of the vehicle body is defined with a water inlet, and the water inlet is in air communicated with the first water outlet to form a first water channel, and is in air communicated with the second water outlet to form a second water channel, the first drive mechanism comprises a first driving motor arranged in the vehicle body, and a first propeller arranged in the first water channel and connected to the first driving motor, the second drive mechanism comprises a second driving motor arranged in the vehicle body, and a second propeller arranged in the second water channel and connected to the second driving motor, and the MCU is connected to the first driving motor and the second driving motor respectively.

5. The swimming pool robot according to claim 4, wherein each of the water inlet, the first water outlet and the second water outlet comprises a one-way valve.

6. The swimming pool robot according to claim 1, wherein four wheels are arranged at four corners of the bottom of the vehicle body, and at least two of the four wheels cannot be rotated, so as to ensure that the swimming pool robot moves forward or backward in a straight line.

7. The swimming pool robot according to claim 1, wherein the vehicle body comprises an arc structure.

8. A control method of a swimming pool robot, wherein the control method is applied to the swimming pool robot as claimed in claim 1, and the control method comprises:
after starting-up the swimming pool robot, acquiring the vehicle body state of the swimming pool robot;
determining whether the swimming pool robot meets the dirt suction condition according to the vehicle body state, wherein the dirt suction condition comprises that the vehicle body is in the water and stays in a bottom of a swimming pool in a static state;
if the vehicle body state meets the dirt suction condition, starting-up one of the first driving mechanism and the second driving mechanism to drive a corresponding one of the first water outlet and the second water outlet to discharge water, and then the swimming pool robot moves forward in a swimming pool.

9. The control method of a swimming pool robot according to claim 8, wherein after the step of if the vehicle-body state meets the dirt suction condition, starting-up one of the first driving mechanism and the second driving mechanism to drive one of the first water outlet and the second water outlet to discharge water, and then the swimming pool robot moves forward in a swimming pool, further comprises:
determining whether the vehicle body collides with a sidewall of the swimming pool and turns; and
if yes, switching the first driving mechanism or the second driving mechanism, so as to switch the drainage of the first water outlet or the second water outlet to drive the swimming pool robot to perform a steering movement.

10. The control method of a swimming pool robot according to claim 8, wherein the control method further comprises:
acquiring the current electric power reserve of the battery;
comparing the current electric power reserve with a preset threshold, when the current electric power reserve is less than or equal to the preset threshold, executing a low power and edge-abutting model.
